(19) United States
(12) Patent Application Publication
(10) Pub. No.: US 2026/0367489 A1
(43) Pub. Date: Nov. 19, 2026

(54) PHOTOGRAPHIC EQUIPMENT AND PHOTOGRAPHIC SLIDING RAIL APPARATUS THEREOF

(71) Applicant: ZHONGSHAN DASHAN PHOTOGRAPHIC EQUIPMENT CO., lTD., Zhongshan (CN)

(72) Inventor: Xihua ZHU, Zhongshan (CN)

(21) Appl. No.: 19/752,642

(22) Filed: Jul. 24, 2026

Related U.S. Application Data
(63) Continuation-in-part of application No. 19/326,786, filed on Sep. 12, 2025.

(30) Foreign Application Priority Data
Sep. 12, 2024 (CN) 202422243847.4
Mar. 27, 2026 (CN) 202620401224.1

(51) Int. Cl. G03B 17/56; H04N 23/695

(52) U.S. Cl. CPC G03B 17/561; H04N 23/695

(57) ABSTRACT

The present disclosure provides a photographic sliding rail apparatus and a photographic equipment. The photographic sliding rail apparatus includes: a sliding rail; a sliding seat slidably disposed on the sliding rail along a first direction; a mounting seat rotatably disposed on the sliding seat around a second direction different from the first direction; a first driving unit mounted on the sliding seat and configured to drive the sliding seat to slide along the first direction; and a second driving unit mounted on the sliding seat and configured to drive the mounting seat to rotate about the second direction. Wherein output shafts of the first and second driving units extend towards different directions. In the present disclosure, the photographic apparatus mounted on the photographic sliding rail apparatus can be driven to slide and rotate, thereby satisfying various photographic needs; the entire photographic sliding rail apparatus is compact and small in size.

### CROSS-REFERENCE TO RELATED APPLICATIONS

The present disclosure is a Continuation in part of U.S. Patent Application Ser. No. 19/326,786, filed on Sep. 12, 2025, which claims the priority of Chinese Patent Application No. 202620401224.1, filed on Mar. 27, 2026, the entire contents of which are hereby incorporated by reference.

### TECHNICAL FIELD

The present disclosure relates to the technical field of sliding rails, and more particularly to a photographic equipment and a photographic sliding rail apparatus.

### BACKGROUND

With the development of photography technology, various photographic equipment such as lenses, camera tripods, and sliding rail apparatuses have emerged one after another, and people’s requirements for photographic equipment are also increasing. Sliding rail apparatuses enable cameras and other photographic apparatus to slide within a certain range, thereby assisting in shooting, making the footage smoother and more vivid, and have become an indispensable necessity.

Currently, photographic equipment with sliding rail on the market have a single function, and most of them are manually adjusted. Their single function makes it impossible to flexibly adjust the various distances and angles required for shooting, which greatly affects photography work.

### SUMMARY

In view of this, the present disclosure provides a photographic equipment and a photographic sliding rail apparatus capable of automatic sliding and rotation, so as to ameliorate the above problems or at least to some extent solve the above technical problems.

To achieve the above objective, the present disclosure provides a photographic sliding rail apparatus including:
a sliding rail;
a sliding seat slidably disposed on the sliding rail along a first direction;
a mounting seat rotatably disposed on the sliding seat about a second direction, the second direction being different from the first direction;
a first driving unit mounted on the sliding seat and configured to drive the sliding seat to slide along the first direction; and
a second driving unit mounted on the sliding seat and configured to drive the mounting seat to rotate about the second direction;
wherein an output shaft of the first driving unit and an output shaft of the second driving unit extend towards different directions.

In some embodiments, the first driving unit includes a first motor and a first transmission mechanism, and the second driving unit includes a second motor and a second transmission mechanism; a rotating shaft of the first motor is connected to the sliding rail via the first transmission mechanism, and a rotating shaft of the second motor is connected to the mounting seat via the second transmission mechanism; in the second direction, the first transmission mechanism and the second transmission mechanism are located on opposite sides of a whole formed by the first motor and the second motor respectively.

In some embodiments, a first rotating shaft of the first motor and a second rotating shaft of the second motor extend towards different directions.

In some embodiments, the first driving unit includes a first motor and a first transmission mechanism, and the second driving unit includes a second motor and a second transmission mechanism; the first motor and the second motor are located in a first accommodation region, the first transmission mechanism is located in a second accommodation region, and the second transmission mechanism is located in a third accommodation region; along the second direction, the second accommodation region and the third accommodation region are located on two opposite sides of the first accommodation region respectively.

In some embodiments, the second direction is perpendicular to the first direction.

In some embodiments, the photographic sliding rail apparatus further includes a battery, the battery is connected to the first driving unit and the second driving unit to supply power to the first driving unit and the second driving unit, and the battery is disposed in the sliding seat.

In some embodiments, the sliding seat includes a base; along the second direction, the base includes a first side and a second side opposite to the first side; the rotating shaft of the first motor passes through the base from the first side towards the second side, and the rotating shaft of the second motor passes through the base from the second side towards the first side.

In some embodiments, the base includes a first portion and a second portion adjacent to the first portion, the first portion and the second portion are spaced apart from each other, the first portion is recessed from the first side toward the second side to form a first recess, the second portion is recessed from the second side toward the first side to form a second recess; a main body of the first motor is mounted in the first recess of the base, and a main body of the second motor is mounted in the second recess of the base.

In some embodiments, the sliding seat further includes a first housing and a second housing covering the first side and the second side of the base respectively, the first housing covers one side of the first driving unit, and the second housing covers one side of the second driving unit.

In some embodiments, the sliding rail includes a first slide rod and a second slide rod parallel to the first slide rod, and the first slide rod and the second slide rod are spaced apart from each other; each side of two sides of the base is provided with an engaging portion extending along the first direction, each engaging portion defines a slide groove therein; the sliding seat further includes a cover plate and a bushing, the cover plate is engaged with the engaging portion of the base and covers an opening of the slide groove to form a channel, the first slide rod and the second slide rod are movably disposed within the channel formed by the engaging portions and the cover plate.

In some embodiments, the first rotating shaft of the first motor and the second rotating shaft of the second motor are parallel to each other; the first transmission mechanism includes a first synchronous pulley, a second synchronous pulley, a third synchronous pulley, a fourth synchronous pulley, a first synchronous belt and a second synchronous belt; the first synchronous pulley, the second synchronous pulley, the third synchronous pulley and the fourth synchronous pulley are all rotatably disposed on the sliding seat; the first synchronous pulley is connected to the first rotating shaft of the first motor; the first synchronous belt is wound around the first synchronous pulley and the second synchronous pulley; the third synchronous pulley is coaxially arranged with the second synchronous pulley; the second synchronous belt is wound around the third synchronous pulley and the fourth synchronous pulley; each of two ends of the second synchronous belt pass around one of the fourth synchronous pulleys respectively, and the two ends of the second synchronous belt are connected to two brackets connected to the sliding rail respectively.

In some embodiments, the second transmission mechanism includes a fifth synchronous pulley, a sixth synchronous pulley and a third synchronous belt; the fifth synchronous pulley and the sixth synchronous pulley are rotatably disposed on the sliding seat; the fifth synchronous pulley is connected to the second rotating shaft of the second motor; the third synchronous belt is wound around the fifth synchronous pulley and the sixth synchronous pulley; the mounting seat is connected to the sixth synchronous pulley.

In some embodiments, the mounting seat includes a shaft sleeve and a shaft table, the sixth synchronous pulley is coaxially arranged with the shaft sleeve, the shaft table is connected to the shaft sleeve, and the shaft table is configured to mount an electronic control installation platform.

In some embodiments, a slip ring is provided between the sliding seat and the mounting seat, the slip ring includes a fixed portion and a rotating portion, the fixed portion is fixedly connected to the sliding seat, the rotating portion is rotatably sleeved within the fixed portion, and the rotating portion being fixedly connected to the mounting seat; the fixed portion is electrically connected to an electrical module inside the sliding seat, and the mounting seat is provided with conductive terminals, the rotating portion is electrically connected to the conductive terminals.

In some embodiments, the photographic sliding rail apparatus further includes two brackets and a plurality of legs, two ends of the sliding rail is fixedly connected to one bracket; the legs are movably connected to the brackets such that each leg has a first support state and a second support state; in the first support state, each leg is received in a groove of the brackets; in the second support state, the leg at least partially extends out of the groove of the bracket in the second direction.

In some embodiments, a first circuit board is provided in the sliding seat, the first circuit board is electrically connected to the first motor and the second motor, and the first circuit board is fixedly mounted on the base of the sliding seat.

In another aspect, a photographic sliding rail apparatus is provided. The photographic sliding rail apparatus includes:
a sliding rail;
a sliding seat slidably arranged on the sliding rail in a first direction;
a mounting seat rotatably arranged on the sliding seat about a second direction, the second direction being different from the first direction;
a first drive assembly mounted on the sliding seat and configured to drive the sliding seat to slide along the first direction;
a second drive assembly mounted on the sliding seat and configured to drive the mounting seat to rotate about the second direction; and
a battery electrically connected to a first motor of the first drive assembly and a second motor of the second drive assembly to supply power to the first motor and the second motor, wherein the battery is disposed inside the sliding seat.

In some embodiments, the first drive assembly further includes a first transmission mechanism, the second drive assembly further includes a second transmission mechanism; and along the second direction, the first transmission mechanism, the second transmission mechanism, and the combination of the first motor and the second motor as a whole are arranged in three layers.

In yet another aspect, a photographic equipment is provided. The photographic equipment includes:
a photographic apparatus; and
the above-described photographic sliding rail apparatus;
wherein the photographic apparatus is connected to photographic sliding rail apparatus directly or indirectly.

In the present disclosure, linear motion and rotation can be respectively achieved by the first driving unit and the second driving unit, driving the photographic equipment mounted on the photographic sliding rail device to slide and rotate, thereby satisfying various photographic needs. Moreover, both the first driving unit and the second driving unit are arranged on the sliding seat, and by having the output shafts of the first and second drive assemblies oriented towards different directions, therefore the entire photographic sliding rail apparatus is made compact and small in size.

### BRIEF DESCRIPTION OF DRAWINGS

In order to more clearly illustrate the technical solutions of the embodiments of the present disclosure, the drawings used below for the description of the embodiments will be introduced briefly. It should be understood that the following drawings only illustrate some embodiments of the present disclosure, and therefore should not be considered as a limitation to the scope. A person skilled in the art may further obtain other relevant drawings according to these drawings without creative work.

FIG. 1 is a schematic, assembled structural view of a photographic sliding rail apparatus according to a first embodiment of the present disclosure, viewed from one angle.

FIG. 2 is a schematic, assembled structural view of the photographic sliding rail apparatus shown in FIG. 1, viewed from another angle.

FIG. 3 is a schematic view of some components of the photographic sliding rail apparatus shown in FIG. 1, viewed from one angle.

FIG. 4 is a schematic view of some components of the photographic sliding rail apparatus shown in FIG. 1, viewed from another angle.

FIG. 5 is a cross-sectional view of the photographic sliding rail apparatus shown in FIG. 1, taken in one direction.

FIG. 6 is an exploded, schematic view of the photographic sliding rail apparatus shown in FIG. 1, viewed from one angle.

FIG. 7 is an exploded, schematic view of the photographic sliding rail apparatus shown in FIG. 1, viewed from another angle.

FIG. 8 is a schematic, structural view of a shaft table and an electronic control installation platform of the photographic sliding rail apparatus shown in FIG. 1, viewed from one angle.

FIG. 9 is a schematic structural view of the shaft table and the electronic control installation platform of the photographic sliding rail apparatus shown in FIG. 1, viewed from another angle.

FIG. 10 is a cross-sectional view of the photographic sliding rail apparatus shown in FIG. 1, taken in another direction.

FIG. 11 is a schematic view of a photographic equipment according to an embodiment of the present disclosure.

FIG. 12 is a perspective schematic view of an electrically controlled sliding apparatus for photographic equipment according to a second embodiment of the present disclosure.

FIG. 13 is an exploded schematic view of the electrically controlled sliding apparatus shown in FIG. 12.

FIG. 14 is a perspective schematic view of a combination of the sliding seat and shaft table of the electrically controlled sliding apparatus shown in FIG. 12 with the electronic control installation platform.

FIG. 15 is a perspective schematic view of the sliding seat and shaft table separated from the electronic control installation platform shown in FIG. 14.

FIG. 16 is a perspective schematic view of the sliding seat and the shaft table of the electrically controlled sliding apparatus shown in FIG. 13.

FIG. 17 is a perspective sectional view of the sliding seat and the shaft table shown in FIG. 16.

FIG. 18 is an exploded schematic view of the sliding seat and the shaft table shown in FIG. 16.

FIG. 19 is a perspective schematic view of a conductive slip ring in FIG. 18.

FIG. 20 is a perspective sectional view of the sliding seat and the shaft table shown in FIG. 16 from another angle.

FIG. 21 is a partial schematic view of a base in the electrically controlled sliding apparatus shown in FIG. 13.

FIG. 22 is a partial perspective schematic view of the base shown in FIG. 21.

FIG. 23 is a partial perspective schematic view of the base shown in FIG. 22.

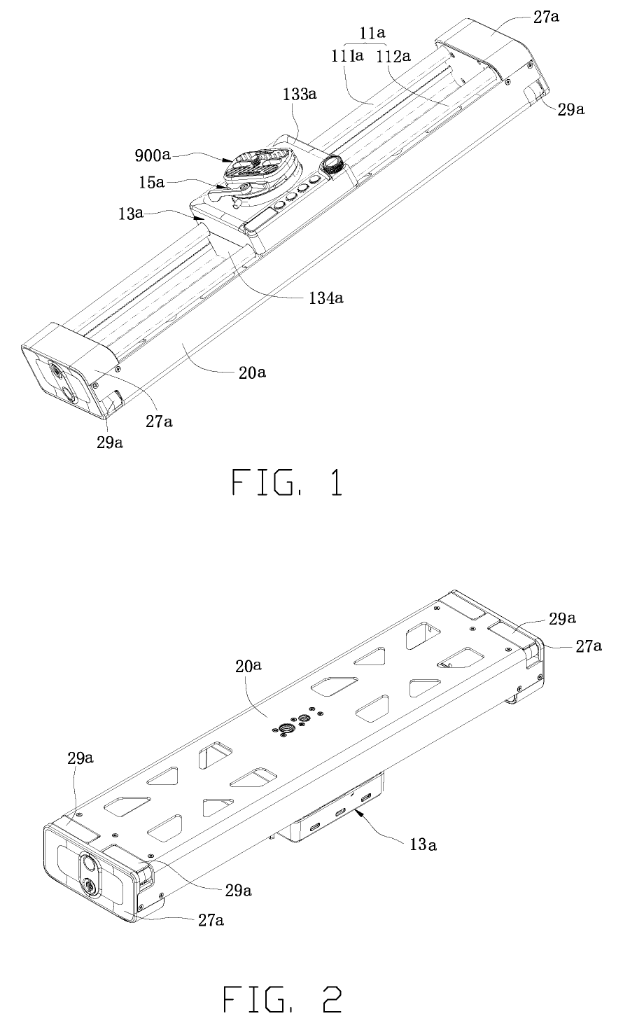

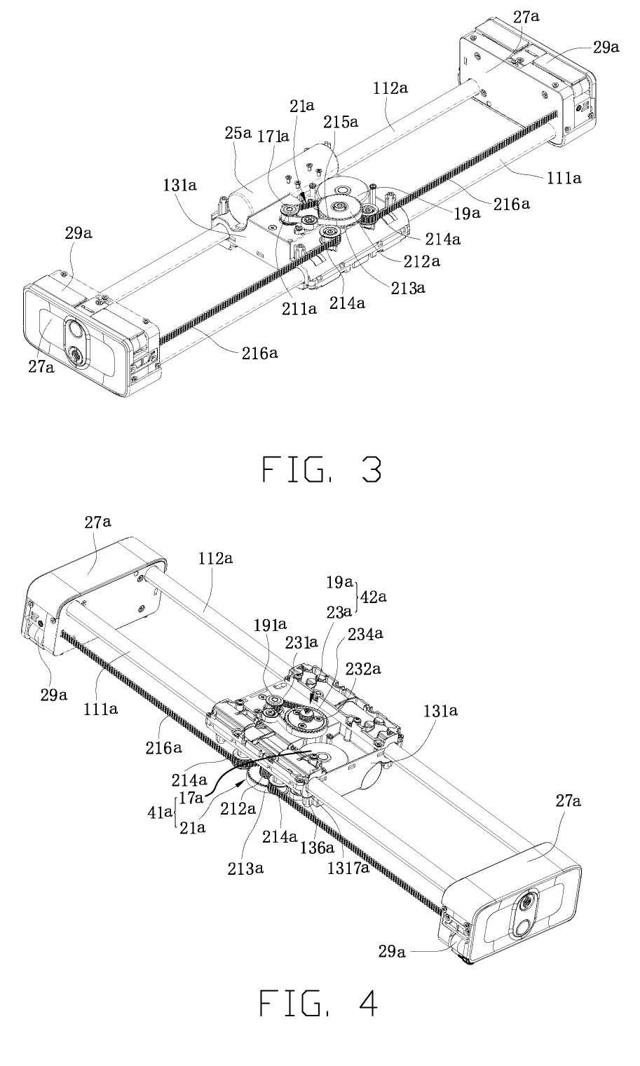

### DESCRIPTION OF EMBODIMENTS

Specific embodiments of the present disclosure will now be described in detail below with reference to the accompanying drawings. Obviously, the described embodiments are only some of the embodiments of the present disclosure, rather than all of the embodiments. Based on the description of the present disclosure, all other embodiments obtained by a person of ordinary skill in the art without creative work shall fall within the protection scope of the present disclosure.

Unless otherwise explicitly specified and defined, the terms “arranged”, “installed”, “connected” and the like shall be understood in broad sense, which may, for example, refer to fixed connection, detachable connection or integral connection; may refer to mechanical connection or electrical connection; and may refer to direct connection or indirect connection through an intermediate medium. A person of ordinary skill in the art can understand the specific meaning of the terms in the present disclosure according to specific situations.

The terms “first”, “second”, “third” and so forth are used only for distinguishing similar elements from each other, rather than for indicating or implying relative importance or specific sequence between these elements.

The terms “comprise”, “include” and any other variations thereof are intended to cover non-exclusive inclusion, including not only those elements listed, but also other elements not explicitly listed.

### First Embodiment

The present disclosure provides a photographic sliding rail apparatus. Referring to FIGS. 1- FIG. 4, a photographic sliding rail apparatus according to a first embodiment includes a sliding rail 11a, a sliding seat 13a, a mounting seat 15a, a first driving unit 41a and a second driving unit 42a. The sliding seat 13a is slidably disposed on the sliding rail 11a along a first direction. The mounting seat 15a is rotatably disposed on the sliding seat 13a around a second direction perpendicular to the first direction. The first driving unit 41a and the second driving unit 42a are mounted on the sliding seat 13a. The first driving unit 41a is configured to drive the sliding seat 13a to slide along the first direction, and the second driving unit 42a is configured to drive the mounting seat 15a to rotate around the second direction. An output shaft of the first driving unit 41a and an output shaft of the second driving unit 42a extend towards different directions. It can be understood that the second direction may also be not perpendicular to the first direction, but intersect with the first direction at an angle other than 90°, as long as the second direction is different from the first direction.

In the embodiments of the present disclosure, linear motion and rotation can be respectively achieved by the first driving unit and the second driving unit, driving a photographic equipment mounted on the photographic sliding rail apparatus to slide and rotate, thereby satisfying various photographic needs; moreover, both the first driving unit and the second driving unit are arranged on the sliding seat, and the output shafts of the first and second drive units are oriented towards different directions, therefore the entire photographic sliding rail apparatus is made compact and small in size.

In one embodiment, the output shaft of the second driving unit 42a may extend in the second direction, and the output shaft of the first driving unit 41a may extend parallel to the second direction.

In one embodiment, the first driving unit 41a includes a first motor 17a and a first transmission mechanism 21a, and the second driving unit 42a includes a second motor 19a and a second transmission mechanism 23a. The first transmission mechanism 21a is connected to a first rotating shaft 171a of the first motor 17a. The second transmission mechanism 23a is connected to a second rotating shaft 191a of the second motor 19a.

In one embodiment, the first rotating shaft 171a of the first motor 17a is connected to the sliding rail 11a via the first transmission mechanism 21a, and the second rotating shaft 191a of the second motor 19a is connected to the mounting seat 15a via the second transmission mechanism 23a. In the second direction, the first transmission mechanism 21a and the second transmission mechanism 23a are located on opposite sides of a whole formed by the first motor 17a and the second motor 19a respectively. Specifically, in the embodiment shown in the figures, the first transmission mechanism 21a is located above the first motor 17a and the second motor 19a, while the second transmission mechanism 23a is located below the first motor 17a and the second motor 19a. That is, the first motor 17a and the second motor 19a as a whole, the first transmission mechanism 21a, and the second transmission mechanism 23a are arranged in three layers, making the entire photographic sliding rail apparatus compact and small in size. In this embodiment, the first rotating shaft 171a of the first motor 17a and the second rotating shaft 191a of the second motor 19a face different directions (e.g., opposite directions). In this embodiment, the first rotating shaft 171a and the second rotating shaft 191a are parallel to each other. It can be understood that in other embodiments, the first rotating shaft 171a of the first motor 17a and the second rotating shaft 191a of the second motor 19a may also be perpendicular to each other; for example, the second rotating shaft 191a of the second motor 19a may orient a direction parallel to the first direction, in which case a different transmission mechanism is required to convert the power from the second rotating shaft 191a arranged parallel to the first direction to the output shaft direction of the second driving unit 42a (the output shaft of the second driving unit 42a extends along the second direction in this embodiment).

Specifically, in this embodiment, the first rotating shaft 171a of the first motor 17a and the second rotating shaft 191a of the second motor 19a extend towards different directions. More specifically, the first rotating shaft 171a of the first motor 17a and the second rotating shaft 191a of the second motor 19a extend in opposite directions. It can be understood that in other embodiments, the extending directions of the first rotating shaft 171a of the first motor 17a and the second rotating shaft 191a of the second motor 19a are not limited; regardless of how the extending directions of the first rotating shaft 171a of the first motor 17a and the second rotating shaft 191a of the second motor 19a are arranged, it is sufficient that the output shaft of the first driving unit 41a and the output shaft of the second driving unit 42a extend towards different directions respectively through the conversion of the first transmission mechanism 21a and the second transmission mechanism 23a.

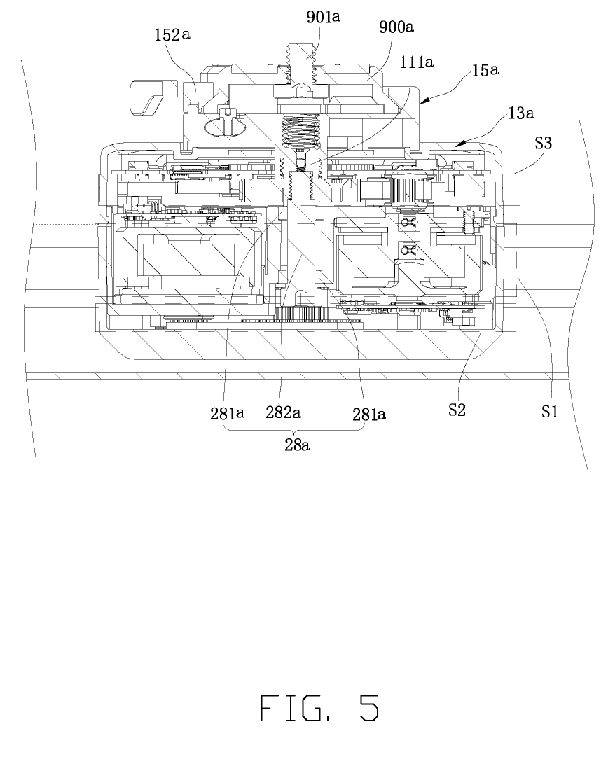

In one embodiment, referring to FIG. 5, the first motor 17a and the second motor 19a are located in a first accommodation region S1, the first transmission mechanism 21a is located in a second accommodation region S2, and the second transmission mechanism 23a is located in a third accommodation region S3. Along the second direction, the second accommodation region S2 and the third accommodation region S3 are located on two sides of the first accommodation region S1 respectively, i.e., along the second direction, the first accommodation region S1 is located between the second accommodation region S2 and the third accommodation region S3. Within the first accommodation region S1, a main body of the first motor 17a (the main body mainly refers to the motor housing and the parts inside the housing) and a main body of the second motor 19a may be arranged side by side in a plane perpendicular to the second direction, or may be offset from each other by a certain distance in the second direction, but neither exceeds the range of the first accommodation region S1. The first motor 17a and the second motor 19a as a whole, the first transmission mechanism 21a, and the second transmission mechanism 23a are arranged in three layers, making the entire photographic sliding rail apparatus compact and small in size.

In one embodiment, the photographic sliding rail apparatus further includes a battery 25a, and the battery 25a is disposed in the sliding seat 13a. The battery 25a is electrically connected to the first motor 17a and the second motor 19a respectively, so as to supply power to the first motor 17a and the second motor 19a. In the prior art, the battery is usually disposed on the sliding rail, requiring a movable conductor for sliding conductive contact between the sliding rail and the sliding seat. In the present disclosure, by arranging the battery 25a in the sliding seat 13a, power can be supplied to the first motor 17a and the second motor 19a which are also disposed in the sliding seat 13a. Therefore, there is no need to provide a movable conductor for electrical connection, resulting in a simple structure, high reliability of electrical conduction, and less susceptibility to damage.

In one embodiment, the sliding rail 11a includes a first slide rod 111a and a second slide rod 112a parallel to the first slide rod 111a, and the first slide rod 111a and the second slide rod 112a are arranged spaced apart from each other. The sliding seat 13a is movably disposed on the first slide rod 111a and the second slide rod 112a along the first direction. Specifically, the first slide rod 111a and the second slide rod 112a extend along the first direction. By providing two slide rods, the movement of the sliding seat 13a can be made more stable. In this embodiment, the first slide rod 111a and the second slide rod 112a are both straight rods. It can be understood that in other embodiments, the first slide rod 111a and the second slide rod 112a may also be curved rods, as long as the sliding seat 13a can slide smoothly thereon.

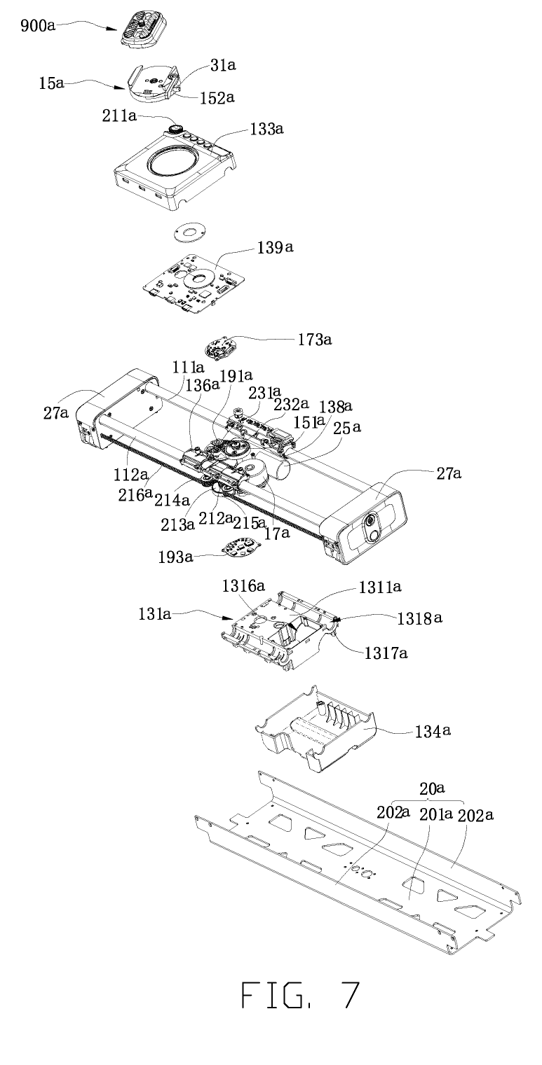

Specifically, a housing 20a is connected to a bottom of the sliding rail 11a. More specifically, the housing 20a includes a bottom plate 201a and two side walls 202a perpendicular to the bottom plate 201a (see FIG. 7). The bottom plate 201a covers the bottoms of the sliding seat 13a, the first motor 17a, the second motor 19a, the first transmission mechanism 21a and the second transmission mechanism 23a.

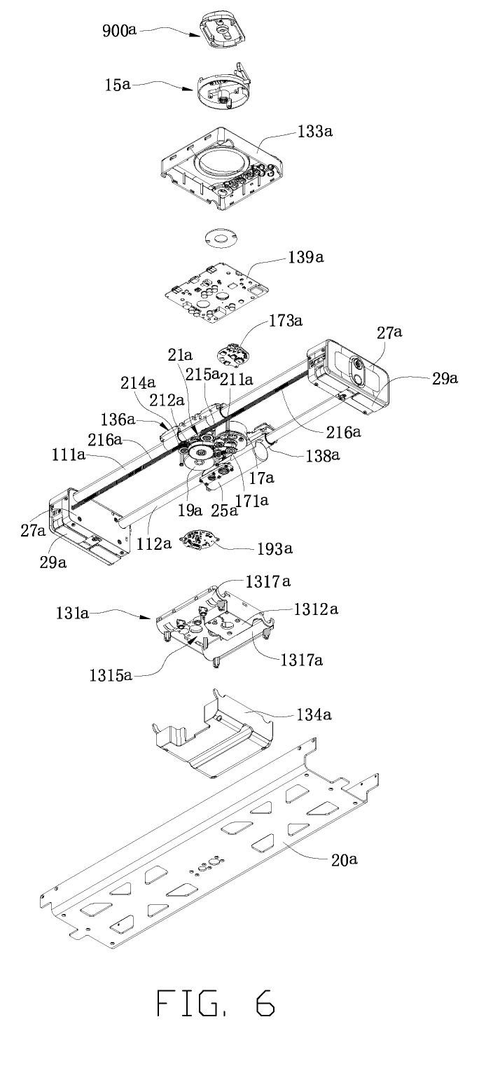

In one embodiment, referring to FIGS. 6 and FIG. 7, the sliding seat 13a includes a base 131a. Along the second direction, the base 131a includes a first side and a second side opposite to the first side. The first rotating shaft 171a of the first motor 17a passes through the base 131a from the first side towards the second side, and the second rotating shaft 191a of the second motor 19a passes through the base 131a from the second side towards the first side. In one embodiment, the first motor 17a and the second motor 19a are disposed in the base 131a, the first transmission mechanism 21a is disposed at the second side of the base 131a, and the second transmission mechanism 23a is disposed at the first side of the base 131a.

Specifically, the base 131a includes a first portion 1311a and a second portion 1312a adjacent to the first portion 1311a, and the first portion 1311a and the second portion 1312a are spaced apart from each other. The first portion 1311a is recessed from the first side of the base 131a toward the second side to form a first recess 1315a, and the second portion 1312a is recessed from the second side of the base 131a toward the first side to form a second recess 1316a. Both the first recess 1315a and the second recess 1316a are located in the first accommodation region S1. The main body of the first motor 17a is mounted in the first recess 1315a of the base 131a, and the main body of the second motor 19a is mounted in the second recess 1316a of the base 131a. Specifically, the first portion 1311a and the second portion 1312a may share a common side wall. More specifically, the bottom of the first recess 1315a and the top of the second recess 1316a may be flush, and the bottom of the second recess 1316a and the top of the first recess 1315a may be flush. The main bodies of the first motor 17a and the second motor 19a may lie in the same plane, or may be offset from each other by a certain distance in the second direction, but the offset distance should not be too large, ensuring that both the first motor 17a and the second motor 19a are located within the first accommodation region S1.

Specifically, two engaging portions 1317a extending along the first direction are provided at two sides of the base 131a respectively. More specifically, each engaging portion 1317a defines a slide groove 1318a therein.

Specifically, the sliding seat 13a further includes a first housing 133a and a second housing 134a covering the first side and the second side of the base 131a respectively. The first housing 133a covers one side of the first motor 17a and the second transmission mechanism 23a, and the second housing 134a covers one side of the second motor 19a and the first transmission mechanism 21a. Specifically, the mounting seat 15a is disposed on the top of the first housing 133a.

Specifically, the sliding seat 13a further includes a cover plate 136a. The cover plate 136a is engaged with the engaging portions 1317a of the base 131a and covers an opening of the slide groove 1318a to form a channel. The first slide rod 111a and the second slide rod 112a are movably disposed within the channel formed by the engaging portions 1317a and the cover plate 136a.

Specifically, a bushing 138a is sleeved over each of the first slide rod 111a and the second slide rod 112a, and the bushing 138a is located within the channel formed by the engaging portions 1317a and the cover plate 136a. When the sliding seat 13a moves on the sliding rail 11a, the bushing 138a moves together with the sliding seat 13a, which allows smoother sliding and avoids wear of the sliding seat 13a.

In one embodiment, the first rotating shaft 171a of the first motor 17a and the second rotating shaft 191a of the second motor 19a are parallel to each other. The first transmission mechanism 21a includes a first synchronous pulley 211a, a second synchronous pulley 212a, a third synchronous pulley 213a, a fourth synchronous pulley 214a, a first synchronous belt 215a and a second synchronous belt 216a. The first synchronous pulley 211a, the second synchronous pulley 212a, the third synchronous pulley 213a and the fourth synchronous pulley 214a are all rotatably disposed on the sliding seat 13a. The first synchronous pulley 211a is connected to the first rotating shaft 171a of the first motor 17a. The first synchronous belt 215a is wound around the first synchronous pulley 211a and the second synchronous pulley 212a. The third synchronous pulley 213a is coaxially arranged with the second synchronous pulley 212a. The second synchronous belt 216a is wound around the third synchronous pulley 213a and the fourth synchronous pulley 214a. Each end of two ends of the second synchronous belt 216a passes around one of the fourth synchronous pulleys 214a, and two ends of the second synchronous belt 216a are connected to two brackets 27a connected to the sliding rail 11a respectively. It can be understood that in the embodiment shown in the figures, the fourth synchronous pulley 214a serves as the output shaft of the first driving unit 41a.

In one embodiment, the second transmission mechanism 23a includes a fifth synchronous pulley 231a, a sixth synchronous pulley 232a and a third synchronous belt 233a. The fifth synchronous pulley 231a and the sixth synchronous pulley 232a are rotatably disposed on the sliding seat 13a. The fifth synchronous pulley 231a is connected to the second rotating shaft 191a of the second motor 19a. The third synchronous belt 233a is wound around the fifth synchronous pulley 231a and the sixth synchronous pulley 232a. It can be understood that the first transmission mechanism 21a and the second transmission mechanism 23a may also be other transmission mechanisms, such as gear mechanisms, worm gear mechanisms, chain mechanisms, or the like. In addition, the first transmission mechanism 21a and the second transmission mechanism 23a may be omitted, and the sliding seat 13a and the mounting seat 15a may be directly driven by the first motor 17a and the second motor 19a, respectively. It can be understood that in the embodiment shown in the figures, the sixth synchronous pulley 232a serves as the output shaft of the second driving unit 42a.

Specifically, the rotation axes of the second synchronous pulley 212a and the fourth synchronous pulley 214a are arranged adjacent to the first slide rod 111a; the battery 25a is arranged adjacent to the second slide rod 112a; the first rotating shaft 171a of the first motor 17a and the rotation axis of the sixth synchronous pulley 232a are located between the battery 25a and the rotation axis of the second synchronous pulley 212a. In the first direction, the rotation axis of the sixth synchronous pulley 232a is located between the first rotating shaft 171a of the first motor 17a and the second rotating shaft 191a of the second motor 19a.

In one embodiment, the mounting seat 15a includes a shaft sleeve 151a and a shaft table 152a. The sixth synchronous pulley 232a is coaxially arranged with the shaft sleeve 151a, and the shaft table 152a is connected to the shaft sleeve 151a. The second motor 19a drives the shaft sleeve 151a and the shaft table 152a to rotate together via the second transmission mechanism 23a.

Specifically, the shaft sleeve 151a may be fixedly connected to the sixth synchronous pulley 232a by fasteners such as bolts. An outer periphery of the shaft sleeve 151a is provided with external threads, and the shaft table 152a is provided with internal threads. The shaft sleeve 151a and the shaft table 152a may be fixedly connected by threaded manners. Certainly, the shaft sleeve 151a and the shaft table 152a may also be fixedly connected by other manners, such as by fasteners like bolts or pins.

Specifically, a first circuit board 139a is provided in the sliding seat 13a. The first circuit board 139a is electrically connected to electrical components such as the first motor 17a and the second motor 19a to transmit control signals to each electrical component, thereby controlling their operation, for example, controlling the start/stop and rotation speed of the first motor 17a and the second motor 19a. Specifically, in this embodiment, the first circuit board 139a is fixedly mounted on the base 131a of the sliding seat 13a. More specifically, a second circuit board 173a is provided at a bottom of the first motor 17a and a third circuit board 193a is provided at a bottom of the second motor 19a. The second circuit board 173a and the third circuit board 193a may provide control circuits for the first motor 17a and the second motor 19a respectively.

In one embodiment, a slip ring 28a is provided between the sliding seat 13a and the mounting seat 15a. The slip ring 28a includes a fixed portion 281a and a rotating portion 282a. The fixed portion 281a is fixedly connected to the sliding seat 13a, and the rotating portion 282a is rotatably sleeved within the fixed portion 281a. The rotating portion 282a is fixedly connected to the shaft sleeve 151a of the mounting seat 15a. Specifically, the rotating portion 282a may be connected to the shaft sleeve 151a by threaded connection, or by other connection manners such as bolts, which will not be described in detail here.

In one embodiment, the photographic sliding rail apparatus further includes the above-mentioned brackets 27a and legs 29a. Two brackets 27a are respectively fixedly connected to two ends of the sliding rail 11a, and two ends of the housing 20a may be fixedly connected to the two brackets 27a respectively. Each leg 29a is movably connected to one of the brackets 27a such that each leg 29a has a first support state and a second support state. In the first support state, each leg 29a is received in a groove of the bracket 27a. In the second support state, the leg 29a at least partially extends out of the groove of the bracket 27a in the second direction to support the photographic sliding rail apparatus. In the first support state, because the legs 29a are stored in the grooves of the brackets 27a, the volume of the entire photographic sliding rail apparatus is reduced, facilitating storage. Specifically, in this embodiment, the leg 29a are rotatably connected to the bracket 27a. More specifically, each leg 29a is rotatably connected to the respective bracket 27a about a direction parallel to the first direction. In this embodiment, each bracket 27a is connected with two legs 29a, and the two legs 29a rotate in opposite directions, so that in the second support state, the two legs 29a form a V-shape.

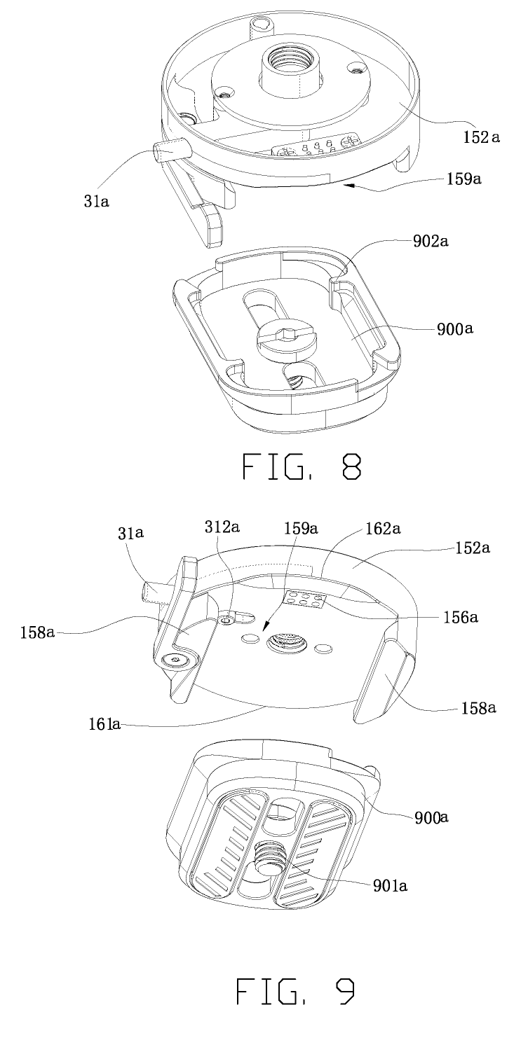

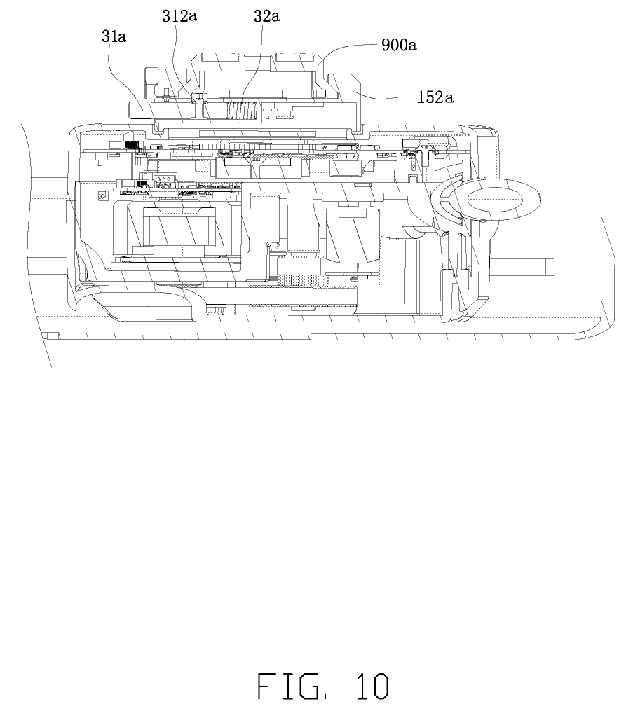

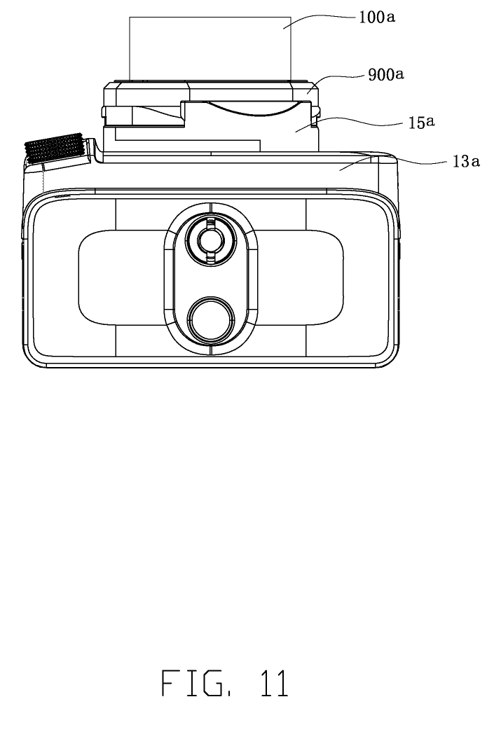

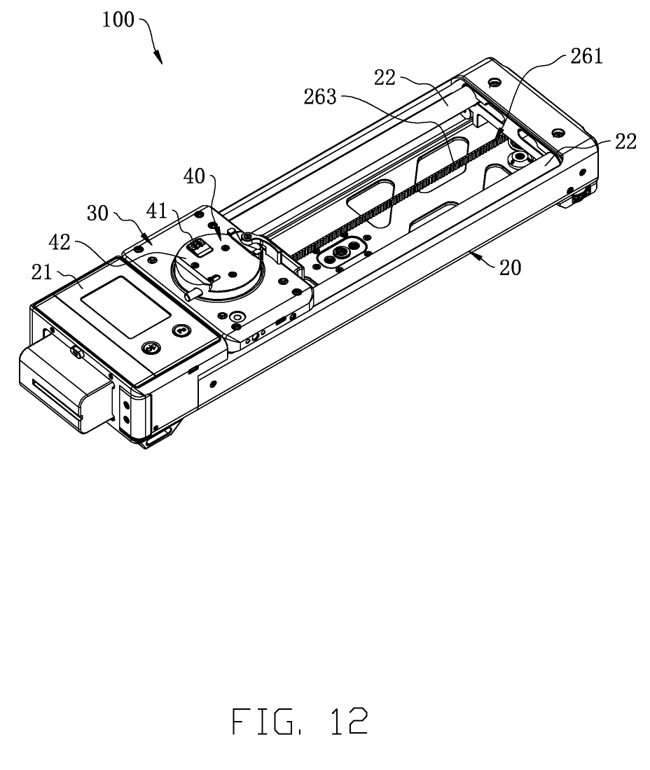

In one embodiment, referring to FIGS. 8 - FIG. 10, the photographic sliding rail apparatus is configured to mount and connect an electronic control installation platform 900a. The photographic sliding rail apparatus is capable of driving the electronic control installation platform 900a to move along the first direction and rotate about the second direction. The electronic control installation platform 900a is used for mounting or connecting a camera and includes an electric control device. The electronic control installation platform 900a may be an electronic camera pan/tilt head for driving the camera to rotate about one or more axes different from the second direction. The electronic control installation platform 900a may also be a stabilizer for eliminating camera shake. Specifically, the electronic control installation platform 900a may be provided with a threaded post 901a to connect a camera or other photographic apparatus to the electronic control installation platform 900a via threaded connection. It can be understood that the photographic sliding rail apparatus may also be used to mount a quick release plate, which is used to directly fix a camera or other photographic apparatus. It can be understood that cameras or other photographic apparatus may also be directly installed on the camera slider device, omitting the electronic control installation platform 900a.

Specifically, the electronic control installation platform 900a has contact terminals (not shown) for electrically connecting to conductive terminals 156a on the mounting seat 15a. After the electronic control installation platform 900a is mounted on the mounting seat 15a of the photographic sliding rail apparatus of this embodiment, the contact terminals of the electronic control installation platform 900a are in conductive contact with the electrical module inside the sliding seat 13a connected to the fixed portion 281a of the conductive slip ring 28a, via the conductive terminals 156a of the mounting seat 15a and the above-mentioned conductive slip ring 28a, thereby achieving electrical connection.

Specifically, the rotating portion 282a of the conductive slip ring 28a is fixedly connected to the mounting seat 15a and rotates together with the mounting seat 15a. The fixed portion 281a is fixedly connected to the sliding seat 13a. The fixed portion 281a is electrically connected to the electrical module, and the rotating portion 282a is electrically connected to the conductive terminals 156a. Therefore, the electrical module is electrically connected to the electronic control installation platform 900a via the conductive slip ring 28a and the conductive terminals 156a, so that power supply current can be output to the electronic control installation platform 900a through the conductive terminals 156a, avoiding the need for the electronic control installation platform 900a to be equipped with a separate battery, which is beneficial for simplifying the structure of the electronic control installation platform 900a. At the same time, the electrical module forms a wired power supply and signal connection with the electronic control installation platform 900a through the conductive terminals 156a, so that motion coordination signals have high stability when transmitted between the electrical module 31 and the electronic control installation platform 900a, thereby avoiding the lack of precise synchronization control between different actions due to signal delay in wireless connections (e.g., Bluetooth connection), and ensuring a good user experience of the photographic sliding rail apparatus. Specifically, the motion coordination signals may be transmitted from the electrical module to the electronic control installation platform 900a, or from the electronic control installation platform 900a to the electrical module. The motion coordination signals are used to maintain a certain synchronization relationship between the translation and rotation of the mounting seat 15a and the motion mode controlled by the electronic control installation platform 900a.

In one embodiment, two oppositely arranged limiting blocks 158a are provided to connect with the shaft table 152a of the mounting seat 15a, and a guiding groove 159a is defined between the two limiting blocks 158a. Specifically, the electronic control installation platform 900a is partially received in the guiding groove 159a. Under the restriction of the limiting blocks 158a, the electronic control installation platform 900a is slidable within the guiding groove 159a. Specifically, a cross section of the guiding groove 159a is approximately dovetail-shaped, and the electronic control installation platform 900a is provided with a structure approximately like a dovetail block to engage with the guiding groove 159a.

In one embodiment, the shaft table 152a is provided with a first end 161a and a second end 162a opposite to the first end 161a. The first end 161a is configured to allow the electronic control installation platform 900a to enter the guiding groove 159a. After the electronic control installation platform 900a slides into the guiding groove 159a from the first end 161a, the electronic control installation platform 900a slides in the direction from the first end 161a to the second end 162a.

In one embodiment, a positioning assembly is mounted on the shaft table 152a. The positioning assembly is used to restrict the electronic control installation platform 900a from withdrawing from the guiding groove 159a, thereby remaining the electronic control installation platform 900a on the mounting seat 15a. Specifically, the positioning assembly may include a sliding pin 31a. In a reset position, the sliding pin 31a is capable of stopping the electronic control installation platform 900a from sliding toward the first end 161a of the shaft table 152a. In an unlocked position, the restriction of the electronic control installation platform 900a by the sliding pin 31a is released.

Specifically, the sliding pin 31a is movably disposed on the electronic control installation platform 900a. The sliding pin 31a is provided with a protrusion 312a, and the electronic control installation platform 900a is provided with a stop block 902a. The protrusion 312a is configured to abut against the stop block 902a to restrict the movement of the electronic control installation platform 900a in the guiding groove 159a toward the first end 161a. When it is desired to remove the electronic control installation platform 900a from the guiding groove 159a, the sliding pin 31a is pressed so that the protrusion 312a disengages from the stop block 902a, thereby allowing the electronic control installation platform 900a to move toward the first end 161a of the guiding groove 159a. The positioning assembly further includes a reset member 32a for providing a force to drive the sliding pin 31a to move, so as to reset the sliding pin 31a. More specifically, the reset member 32a may be an elastic member, two ends of the elastic member abutting against the electronic control installation platform 900a and the sliding pin 31a respectively; when the pressing on the sliding pin 31a is released, the elastic member pushes the sliding pin 31a to automatically reset to the position where the protrusion 312a abuts against the stop block 902a.

The present disclosure further provides a photographic equipment. Referring to FIG. 11, in one embodiment, the photographic equipment includes a photographic apparatus 100a and the above-described photographic sliding rail apparatus. The photographic apparatus 100a is connected to photographic sliding rail apparatus directly or indirectly.

### Second Embodiment

FIGS. 12 - 23 show an electrically controlled sliding apparatus 100 for photographic equipment according to at least one embodiment of the present disclosure. As shown in FIG. 12, the present disclosure provides an electrically controlled sliding apparatus 100 for installing and connecting an electronic control installation platform 900. The electrically controlled sliding apparatus 100 can drive the electronic control installation platform 900 to move along a straight path and rotate around a first axis.

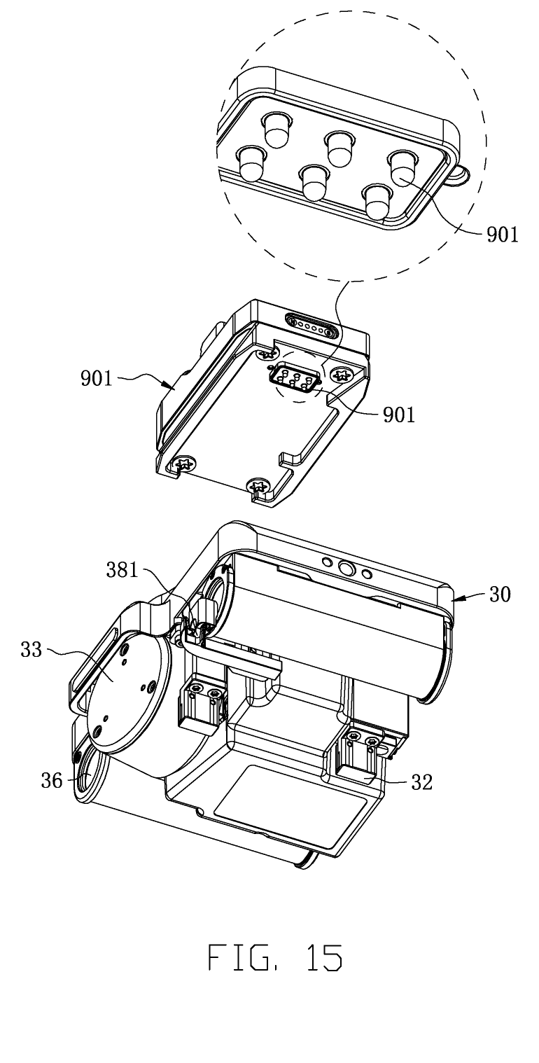

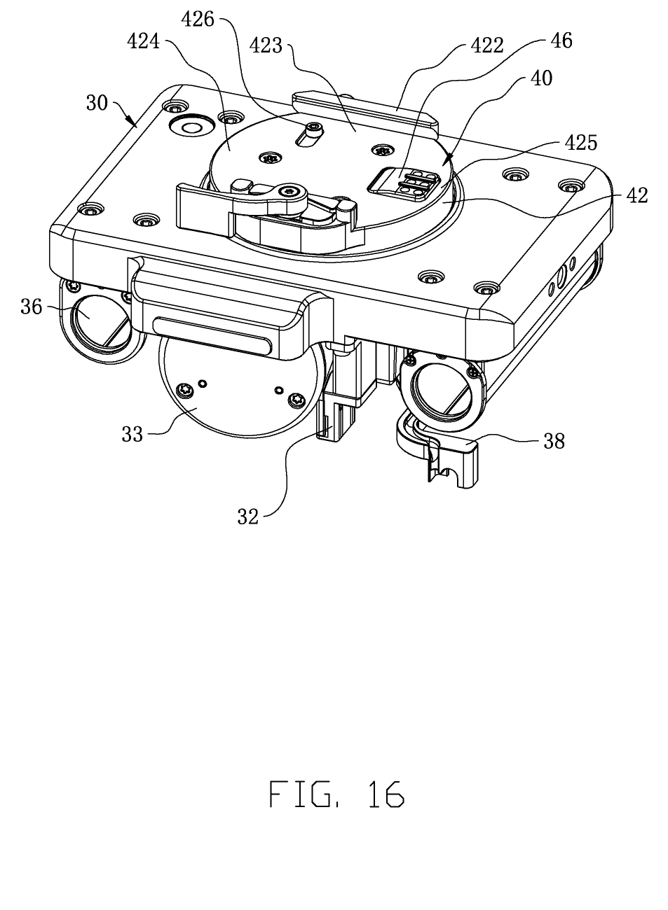

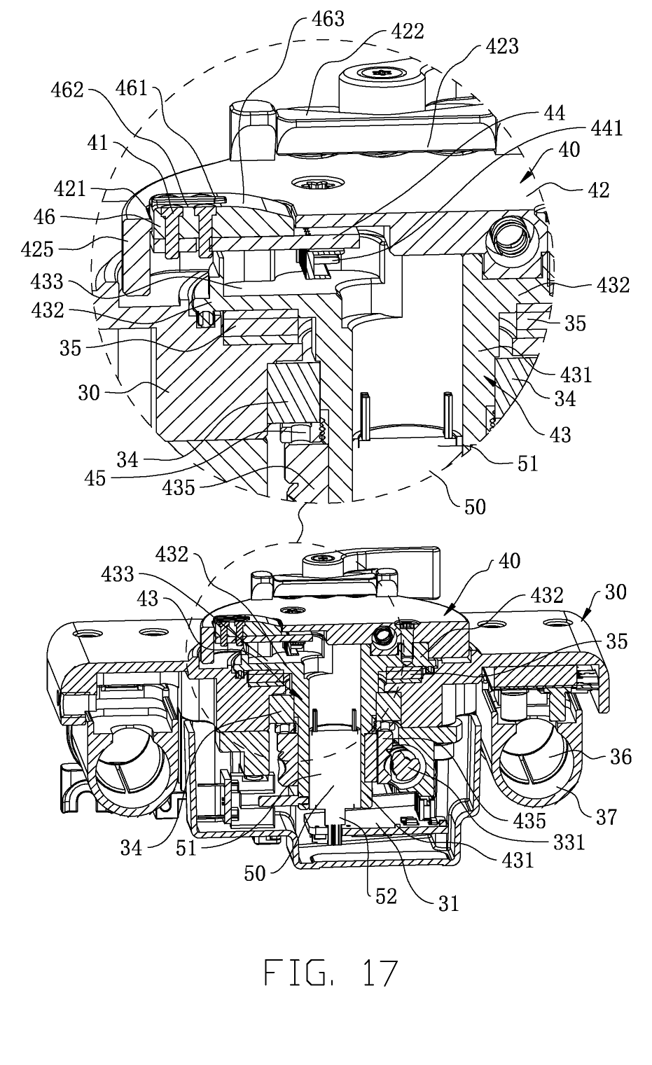

Referring to FIGS. 15 and 16, the electronic control installation platform 900 is used for installing or connecting a camera and includes an electric control device. The electronic control installation platform 900 can be a camera electric control pan-tilt, used to drive the camera to rotate around one or more axes different from the first axis. The electronic control installation platform 900 can also be a stabilizer used to eliminate camera shake.

It can be understood that the electrically controlled sliding apparatus 100 is also used to install a quick mounting plate, which is used to directly fix a camera or other photographic equipment.

Specifically, as shown in FIGS. 16 - 18, the electrically controlled sliding apparatus 100 includes a base 20, a control component 21, a sliding seat 30, a shaft table 40, and a conductive slip ring 50. The control component 21 is mounted inside the base 20. The sliding seat 30 is mounted on the base 20 in a sliding manner, and an electrical module 31 is fixedly mounted inside the sliding seat 30. The electrical module 31 is electrically connected to the control component 21. The shaft table 40 is rotatably mounted on the sliding seat 30, and is used to connect to the electronic control installation platform 900 of the camera. The shaft table 40 is provided with conductive terminals 41 for forming conductive contact with the electronic control installation platform 900. The conductive slip ring 50 forms electrical connections with the electrical module 31 and the conductive terminals 41 of the shaft table 40, respectively.

Specifically, the electronic control installation platform 900 has contact terminals 901 for electrical connection with the conductive terminals 41. After the electronic control installation platform 900 is mounted on the shaft table 40 of the electrically controlled sliding apparatus 100 of the present disclosure, the contact terminals 901 of the electronic control installation platform 900 and the electrical module 31 form a conductive contact through the conductive terminals 41 of the shaft table 40 and the conductive slip ring 50, thereby achieving electrical connection.

The conductive slip ring 50 includes a rotating part 52 and a fixed part 51. The rotating part 52 can rotate relative to the fixed part 51, and the rotating part 52 is in sliding contact with and electrically connected to the fixed part 51, thereby forming a stable electrical connection during rotation.

In this embodiment, the rotating part 52 of the conductive slip ring 50 is fixedly connected to the shaft table 40 and rotates together with the shaft table 40. The fixed part 51 is fixedly connected to the sliding seat 30. The fixed part 51 is electrically connected to the electrical module 31, and the rotating part 52 is electrically connected to the conductive terminals 41. Specifically, the rotating part 52 is electrically connected to the conductive terminals 41 of the shaft table 40 through the lead wire 53, and then forms an electrical connection with the control component 21. Therefore, the control component 21 and the electrical module 31 are electrically connected to the electronic control installation platform 900 through the conductive slip ring 50 and the conductive terminal 41, so that the power supply current can be output to the electronic control installation platform 900 through the conductive terminals 41, avoiding the need for a separate battery for the electronic control installation platform 900 and simplifying its structure. At the same time, the control component 21 and the electrical module 31 form a wired power and signal connection with the electronic control installation platform 900 through the conductive terminals 41, ensuring high stability in the transmission of motion coordination signals between the electrical module 31 and the electronic control installation platform 900, thereby avoiding a lack of precise synchronization control between different actions due to signal delay in wireless connections (such as Bluetooth connections), and ensuring the experience of the electrically controlled sliding apparatus 100.

Specifically, the motion coordination signals can be transmitted from the electrical module 31 to the electrical control installation platform 900, or from the electrical control installation platform 900 to the electrical module 31. The motion coordination signals are used to maintain a certain synchronization relationship between the translations and rotations of the shaft table 40 and the motion modes controlled by the electronic control installation platform 900.

In some embodiments, a structural form of at least one interface end of the conductive slip ring 50 is a lead wire. Specifically, the conductive slip ring 50 is electrically connected to the conductive terminals 41 or the electrical module 31 through lead wires 53. In some embodiments, as shown in FIG. 19, the rotating part 52 of the conductive slip ring 50 includes lead wires 53, and is electrically connected to the conductive terminals 41 through the lead wires 53. In some embodiments, the fixed part 51 of the conductive slip ring 50 includes lead wires 53, and is electrically connected to the electrical module 31 through the lead wires 53.

Specifically, the control component 21 can be connected to an external power source to provide power supply current to the electrical module 31 and the electronic control installation platform 900, ensuring normal operations of the electrical module 31 and the electronic control installation platform 900. The control component 21 can also include built-in batteries, especially rechargeable batteries, to meet the needs of camera power supply while achieving portability.

In some embodiments, the control component 21 can also be used to control linear movements of the sliding seat 30 relative to the base 20. In some embodiments, the control component 21 may also send motion coordination signals to the electrical module 31 and the electronic control installation platform 900. The electrical module 31 and the electronic control installation platform 900 can provide feedback on execution result signals to the control component 21.

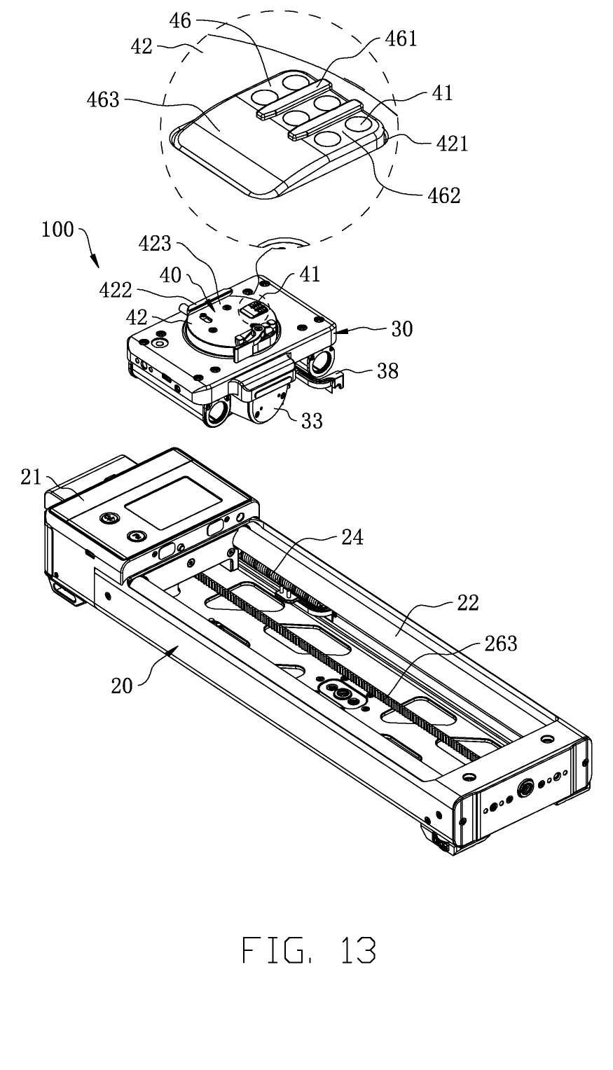

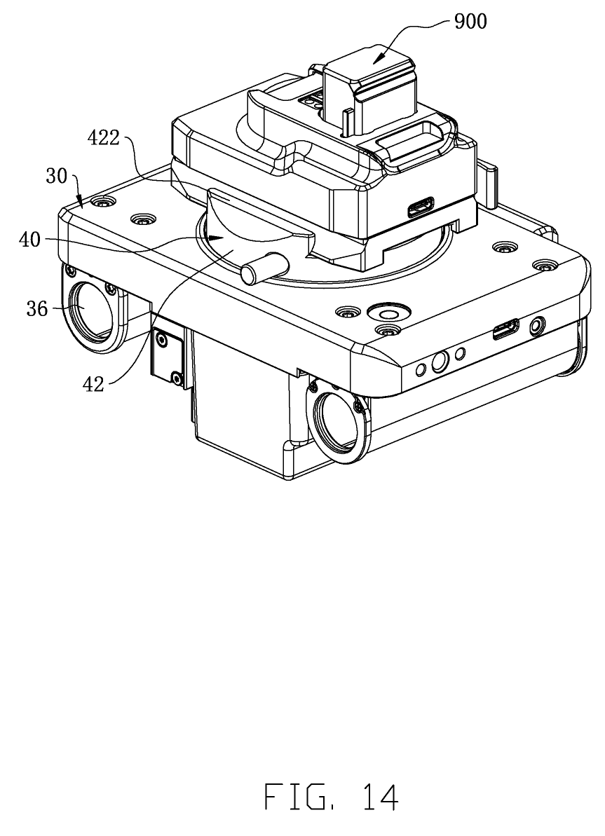

In some embodiments, combining FIGS. 12 and 13, the base 20 is equipped with a guide rod 22. The sliding seat 30 is slidably fitted on an outer peripheral side of the guide rod 22, so that the guide rod 22 guides the sliding direction of the sliding seat 30 relative to the base 20. In some embodiments, two guide rods 22 are mounted parallel to the base 20. Furthermore, the sliding seat 30 is simultaneously limited by two guide rods 22, with a center of the sliding seat 30 located between the two guide rods 22.

Combining FIGS. 16 - 18, the shaft table 40 includes a cover 42 which rotates relative to the sliding seat 30, and an insulating member 46 mounted on the cover 42. Several conductive terminals 41 are inserted at intervals into the insulating member 46. Specifically, several conductive terminals 41 are fixedly inserted into the insulating member 46 at intervals, so as to maintain stable positions between each conductive terminal 41. Due to the insulating properties of the insulating member 46, it prevents short circuiting of the conductive terminals 41. At the same time, the insulating member 46 and the several conductive terminals 41 can form a pre-assembled component. When the insulating member 46 is mounted on the cover 42, several conductive terminals 41 are simultaneously mounted on the cover 42, which is conducive to improving the installation efficiency of the conductive terminals 41.

In other embodiments, when the cover 42 is made of insulating material, the conductive terminals 41 can also be directly mounted on the cover 42.

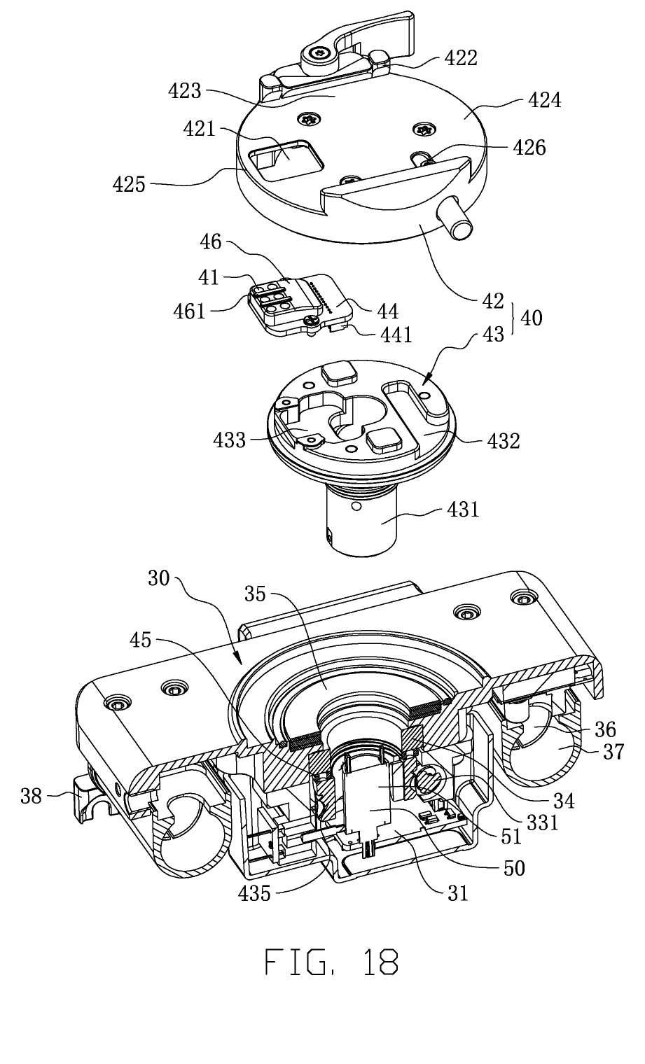

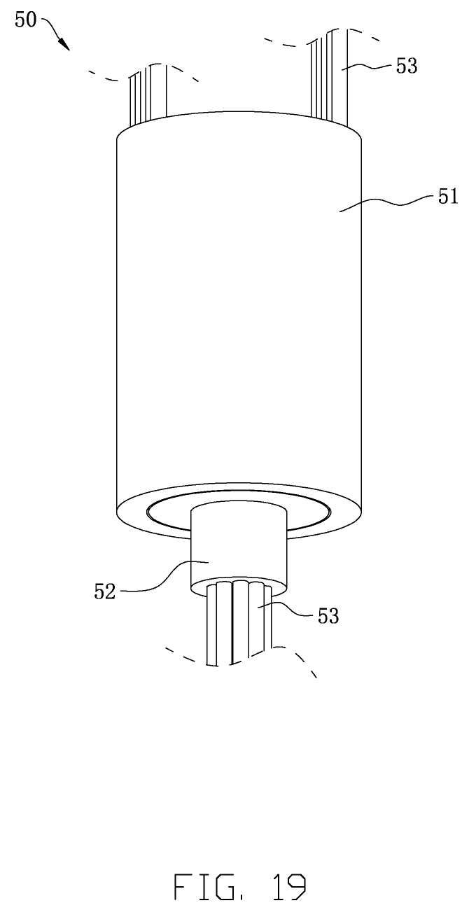

In some embodiments, combining FIGS. 17 and 18, the cover 42 is formed with a groove 421, and the insulating member 46 is mounted in the groove 421, so that an outer surface of the insulating member 46 coincides with or is spaced a small distance away from a portion of a surface of the cover 42. Meanwhile, the conductive terminal 41 can extend to the inside of the cover 42 through the groove 421.

In some embodiments, the insulating member 46 is at least partially exposed on the cover 42, so that after the electronic control installation platform 900 is mounted on the shaft table 40, the outer surface of the insulating member 46 can be opposite to a distribution area of the contact terminals 901 of the electronic control installation platform 900.

In some embodiments, combining FIG. 13, an outer end face of the conductive terminal 41 is flush with an outer surface of the insulating member 46, thereby keeping the outer surface of the insulating member 46 flat. The contact terminal 901 of the electronic control installation platform 900 adopts an elastic pin structure, which avoids the conductive terminal 41 from causing sliding resistance to the contact terminal 901 of the electronic control installation platform 900.

In some embodiments, combining FIG. 13, the insulating member 46 is provided with at least one convex strip section 461. The convex strip section 461 protrudes from the outer surface of the insulating member 46, and is located between the outer end faces of adjacent two conductive terminals 41. Specifically, the convex strip section 461 can maintain a gap between other external metal members and the outer surface of the insulating member 46, avoiding conductive contact between the external metal members and the outer end faces of the two conductive terminals 41 at the same time, and preventing short circuits between the two conductive terminals 41 with potential differences. Specifically, based on the intended use of the conductive terminals 41, it can be determined whether there will be a potential difference between the conductive terminals 41. When laying out the conductive terminals 41, two conductive terminals 41 with potential differences can be placed on both sides of the convex strip section 461.

In some embodiments, combining FIG. 16, the cover 42 is provided with two opposing limit blocks 422. A directional groove 423 is formed between two limit blocks 422. Specifically, the electronic control installation platform 900 is partially accommodated in the directional groove 423. Under the limitation of the limit block 422, the electronic control installation platform 900 is slidably set in the directional groove 423. Specifically, the directional groove 423 is shaped similar to a dovetail groove. A structure similar to a dovetail block is formed on the electronic control installation platform 900 to cooperate with the directional groove 423. Specifically, an extension direction of the convex strip section 461 corresponds to the sliding direction of the electronic control installation platform 900 within the directional groove 423.

In some embodiments, combining FIGS. 16 and 17, the cover 42 is provided with a first end 424 and a second end 425 which are opposite to each other. The first end 424 is used for the electronic control installation platform 900 to enter the directional groove 423. The outer surface of the insulating member 46 includes a matching surface 462 and a transition slope 463 arranged adjacent to each other, with the matching surface 462 protruding relative to a bottom surface of the directional groove 423. The conductive terminals 41 are distributed on the matching surface 462. The transition slope 463 is located near the first end 424 of the cover 42 relative to the matching surface 462. Along a direction from the second end 425 to the first end 424, the transition slope 463 is inclined towards the bottom of the directional groove 423. Specifically, in the case where the contact terminal 901 of the electronic control installation platform 900 adopts an elastic pin structure, when the electronic control installation platform 900 slides into the directional groove 423 from the first end 424, the electronic control installation platform 900 slides in the direction from the first end 424 to the second end 425, and the contact terminal 901 first contacts the transition slope 463. The transition slope 463 gradually compresses the contact terminal 901, preventing the end of the contact terminal 901 from being blocked during sliding. Due to the protrusion of the matching surface 462 relative to the bottom surface of the directional groove 423, and the fact that the outer end surface of the conductive terminal 41 is flush with the matching surface 462, when the contact terminal 901 comes into contact with the conductive terminal 41, the contact terminal 901 of the electronic control installation platform 900 remains in a compressed state, thereby keeping the contact terminal 901 in close contact with the conductive terminal 41 and improving the stability of electrical contact.

In some embodiments, a distance between the insulating member 46 and the second end 425 is smaller than a distance between the insulating member 46 and the first end 424.

In some embodiments, combining FIGS. 16 and 18, the cover 42 is connected with a positioning component, which is used to restrict the electronic control installation platform 900 from exiting from the directional groove 423, thereby limiting the electronic control installation platform 900 to the shaft table 40. At this fixed position, several contact terminals 901 of the electronic control installation platform 900 accurately correspond to several conductive terminals 41 on the cover 42. In some embodiments, the positioning component includes a sliding pin 426. When in a reset position, the sliding pin 426 can stop the electronic control installation platform 900 from sliding towards the first end of the cover 42. When in a unlocked position, the restriction of the sliding pin 426 on the electronic control installation platform 900 is lifted.

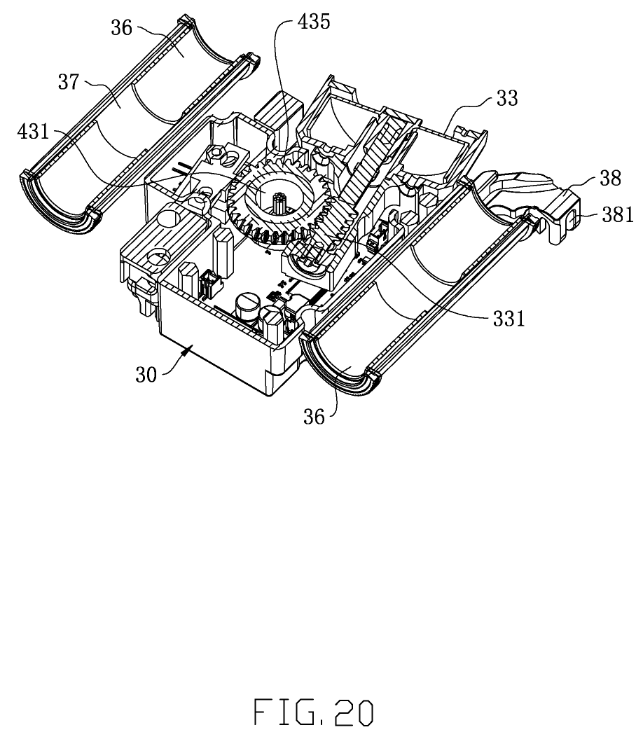

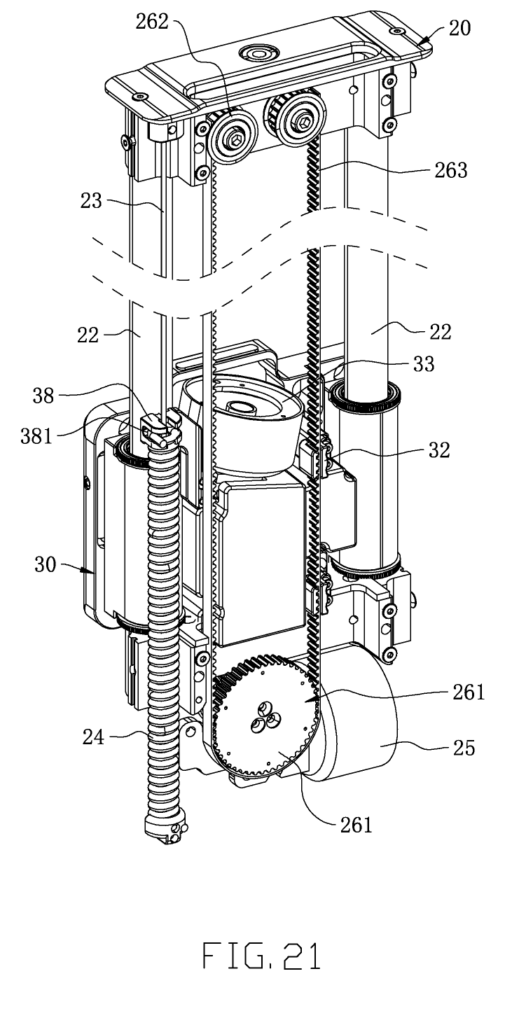

In some embodiments, combining FIGS. 15 and 20, the sliding seat 30 is equipped with a rotating driving member 33. The rotating driving member 33 is used to drive the shaft table 40 to rotate in a circumferential direction. Specifically, under the control of the electrical module 31, the rotating driving member 33 drives the shaft table 40 to rotate in the circumferential direction. The electrical module 31 can specifically be a circuit that can control the rotation of the rotating driving member 33 and form electrical cooperation with the control component 21.

In some embodiments, combining FIGS. 17 and 18, the shaft table 40 also includes a main shaft body 43. The main shaft body 43 includes a shaft cylinder section 431 rotatably accommodated inside the sliding seat 30 and a collar section 432 connected to the shaft cylinder section 431. The cover 42 is connected to the collar section 432. Specifically, the shaft cylinder section 431 forms a rotational fit with the sliding seat 30, and the rotating driving member 33 transmits driving force to the shaft cylinder section 431, causing the shaft table 40 to rotate relative to the sliding seat 30. The outer diameter of the collar section 432 is greater than the outer diameter of the shaft cylinder section 431. Specifically, the shaft cylinder section 431 is arranged in a hollow shape.

Combining FIGS. 17 and 18, in some embodiments, the sliding seat 30 is also equipped with a first radial bearing member 281, which is provided on the outer peripheral side of the shaft cylinder section 431 and on the inner peripheral side of the sliding seat 30. Specifically, due to the first radial bearing member 281 provided on the outer peripheral side of the shaft cylinder section 431 and the sliding seat 30, direct friction between the shaft cylinder section 431 and the sliding seat 30 is avoided, ensuring smooth rotation of the main shaft body 43 and improving the service life of the main shaft body 43 and the sliding seat 30. In some embodiments, the first radial bearing member 281 is a deep groove ball bearing.

In some embodiments, combining FIGS. 17 and 18, the sliding seat 30 further includes an axial bearing member 35, which is disposed on the outer peripheral side of the shaft cylinder section 431 and between the lower side of the collar section 432 and the sliding seat 30. Specifically, the gravity of the electronic control installation platform 900 is applied to the collar section 432, which is located on an upper side of the sliding seat 30. Due to the axial bearing member 35 being located between the lower side of the collar section 432 and the sliding seat 30, direct friction between the collar section 432 and the upper surface of the sliding seat 30 is avoided, ensuring smooth rotation of the main shaft body 43 and improving the service life of the main shaft body 43 and the sliding seat 30. In some embodiments, the axial bearing memeber 35 is a thrust bearing.

In some embodiments, combining FIGS. 17 and 19, the rotating part 52 is fixedly arranged inside the shaft cylinder section 431, and the outer diameter of the rotating part 52 corresponds to the inner diameter of the shaft cylinder section 431. Specifically, by accommodating the rotating part 52 within the shaft cylinder section 431, it is possible to avoid the conductive slip ring 50 occupying other spaces within the sliding seat 30. Due to the outer diameter of the rotating part 52 corresponding to the inner diameter of the shaft cylinder section 431, a change in an axial position of the conductive slip ring 50 can be reduced during the rotation of the main shaft body 43 relative to the sliding seat 30.

In some embodiments, combining FIGS. 17 and 18, the electrically controlled sliding apparatus 100 further includes a circuit board 44. The conductive terminal 41 is fixedly connected to the circuit board 44. A side of the circuit board 44 facing away from the cover 42 is fixed with an interface socket 441. The conductive terminal 41 is electrically connected to the interface socket 441 through the circuit board 44. A cable connected to an interface end of the conductive slip ring 50 is connected to the interface socket 441 through a plug, thereby forming an electrical connection between the interface end of the conductive slip ring 50 and the conductive terminal 41.

In some embodiments, combining FIGS. 17 and 18, the collar section 432 is provided with a receiving groove 433. An opening of the receiving groove 433 faces the cover 42, and the receiving groove 433 is connected to an inner cavity of the shaft cylinder section 431, so that the receiving groove 433 can accommodate the interface socket 441 connected to the circuit board 44 and the plug at the end of the cable. Due to the fact that the receiving groove 433 is connected to the inner cavity of the shaft cylinder section 431, it avoids the need for the cable to pass through narrow positions, which is beneficial for improving the assembly efficiency of the electrically controlled sliding apparatus 100. Specifically, the circuit board 44 is fixed to the collar section 432 by fasteners. Specifically, the conductive terminal 41 is fixed to the circuit board 44 by welding.

In some embodiments, combining FIGS. 19 and 20, the electrically controlled sliding apparatus 100 further includes a wear-resistant member 36. The wear-resistant member 36 is fixedly mounted on the sliding seat 30, and the wear-resistant member 36 is slidably fitted on the outer peripheral side of the guide rod 22. Specifically, the wear-resistant member 36 moves relative to the base 20 with the sliding seat 30 and is spaced between the guide rod 22 and the sliding seat 30, avoiding direct contact between the guide rod 22 and the sliding seat 30, thereby preventing the sliding seat 30 or the guide rod 22 from being worn. In some embodiments, the wear-resistant member 36 is a bushing. Furthermore, the hardness of the wear-resistant member 36 is lower than that of the guide rod 22, effectively reducing the wear of the guide rod 22.

In some embodiments, the sliding seat 30 is provided with a through hole 37. The guide rod 22 is inserted into the through hole 37. The inner diameter of through hole 37 is slightly larger than the outer diameter of the guide rod 22. In some embodiments, the wear-resistant member 36 is fixed within the through-hole 37 through interference fit. The inner diameter of the wear-resistant member 36 is larger than the outer diameter of the guide rod 22, and the guide rod 22 is slidably inserted into the wear-resistant member 36. In other embodiments, the wear-resistant member 36 can also be fixedly connected to the sliding seat 30 through flanges and screws.

In some embodiments, combining FIGS. 17 and 20, an output shaft of the rotating driving member 33 is connected to a second worm 331. A transmission fit is formed between the rotating driving member 33 and the second worm 331, which can drive the second worm 331 to rotate along its own axis.

In some embodiments, combining FIGS. 18 and 20, the outer circumference of the shaft cylinder section 431 is fixedly connected to a second worm wheel 435, and the second worm 331 meshes with the second worm wheel 435. Specifically, in the case where the second worm 331 meshes with the second worm wheel 435, under the transmission effect of the worm and worm wheel form, the second worm wheel 435 can drive the main shaft body 43 to rotate relative to the sliding seat 30 because the second worm wheel 435 is fixedly connected to the shaft cylinder section 431. Due to the installation of the electronic control installation platform 900 on the cover 42 of the main shaft body 43, an angle of the electronic control installation platform 900 relative to the sliding seat 30 can be adjusted by rotating the output shaft of the rotating driving member 33. Therefore, after the position of the sliding seat 30 changes along a straight line direction, the angle adjustment of the main shaft body 43 by the rotating driving member 33 can keep a center of a shooting range of the electronic control installation platform 900 aligned with a shooting target, ensuring a shooting effect. Furthermore, under the transmission effect of the worm and worm wheel, the rotational speed of the shaft table 40 can be much lower than the rotational speed of the output shaft of the rotating driving member 33, which is conducive to accurately adjusting the angle of the electronic control installation platform 900.

In other embodiments, the outer circumference of the main shaft body 43 is formed with a second worm wheel, and the second worm 331 meshes with the second worm wheel. Specifically, when the second worm 331 meshes with the second worm wheel formed on the outer circumference of the main shaft body 43, the second worm 331 directly drives the main shaft body 43 to rotate relative to the sliding seat 30. In some embodiments, the shaft cylinder section 431 is formed with several worm gear teeth protruding outward on the outer peripheral side, and the worm gear teeth mesh and cooperate with the second worm 331. In other embodiments, grooves are provided on the outer side of the shaft cylinder section 431, and several grooves are distributed along the outer circumference of the shaft cylinder section 431. The shaft cylinder section 431 meshes and cooperates with the second worm 331 at the position between adjacent grooves.

In some embodiments, combining FIGS. 17 and 18, the shaft table 40 is connected with a threaded member 45, which is threaded onto the outer peripheral side of the shaft cylinder section 431, and the second worm wheel 435 is threaded onto the outer peripheral side of the shaft cylinder section 431. Specifically, the threaded member 45 and the second worm wheel 435 are respectively threaded onto the outer peripheral side of the shaft cylinder section 431. By using the threaded member 45 to press against the second worm wheel 435 along an axial direction of the shaft cylinder section 431, the second worm wheel 435 can be held in a fixed position and angle relative to the shaft table 40, so that the second worm wheel 435 can drive the shaft table 40 to rotate.

In some embodiments, combining FIGS. 20 and 21, the sliding seat 30 is connected with a bracket 38. One end of bracket 38 is equipped with a slot 381, which surrounds the outer peripheral side of a support strip 23. An elastic spiral conductor 24 is partially embedded in the slot 381. Specifically, by partially embedding the elastic spiral conductor 24 into the slot 381, the bracket 38 plays a limiting role on the elastic spiral conductor 24. When the sliding seat 30 moves relative to the base 20, it can cause the elastic spiral conductor 24 to expand and contract between the bracket 38 and the base 20, and prevent the end of the elastic spiral conductor 24 from electrically loosening relative to the sliding seat 30. More specifically, the bracket 38 is connected to sliding seat 30. In one embodiment, one end of the elastic spiral conductor 24 is embedded in the slot 381, and the other end is fixed to the base 20.

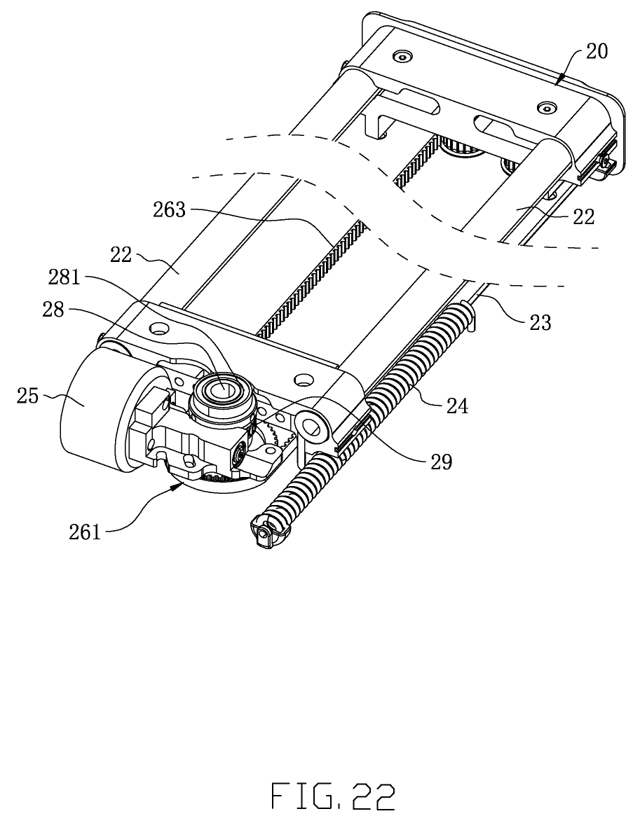

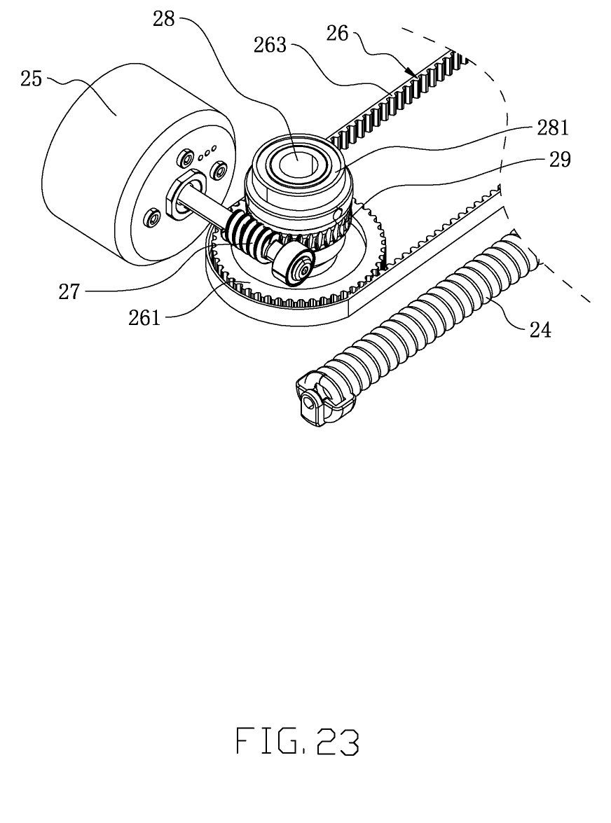

In some embodiments, combining FIGS. 22 and 23, the base 20 is equipped with a support strip 23 and an elastic spiral conductor 24. The extension direction of the support strip 23 corresponds to the sliding direction of sliding seat 30. The elastic spiral conductor 24 is wrapped around the outer peripheral side of the support strip 23. The elastic spiral conductor 24 is electrically connected between the control component 21 and the electrical module 31. Specifically, the elastic spiral conductor 24 is stretchable. When the position of the sliding seat 30 relative to the base 20 changes, the sliding seat 30 stretches the elastic spiral conductor 24, so that the length of the elastic spiral conductor 24 can adapt to the position change of the sliding seat 30 and change accordingly, so that the control component 21 and the electrical module 31 are always electrically connected when the sliding seat 30 is in different positions. The extension direction of support strip 23 is parallel or approximately parallel to the sliding direction of sliding seat 30. The support strip 23 plays a supporting role for the elastic spiral conductor 24, avoiding a sagging of the elastic spiral conductor 24.

In one embodiment, the elastic spiral conductor 24 may include a stretchable spring and a flexible conductor, with the flexible conductor spiral attached to the stretchable spring, and the flexible conductor and the stretchable spring surrounded by a same insulating sleeve. In another embodiment, the elastic spiral conductor 24 may include an elastic conductor surrounded by an insulating sleeve. Specifically, the elastic conductor has a memory form, and after a tension applied to the elastic conductor is eliminated, the elastic conductor can contract to the memory form. Specifically, the elastic conductor can be an elastic spiral metal wire.

In some embodiments, the support strip 23 is a nylon rope in a stretched state. Furthermore, the two ends of the support strip 23 are respectively fixed to the base 20. In other embodiments, the support strip 23 may also be a metal rod.

In some embodiments, combining FIGS. 21 - 23, the electrically controlled sliding apparatus 100 further includes a displacement driving member 25 and a transmission component 26 mounted on the base 20. Specifically, the displacement driving member 25 drives the sliding seat 30 to linearly slide relative to the base 20 through the transmission assembly 26. Under the control of control component 21, the displacement driving member 25 drives the sliding seat 30 to slide linearly. The control component 21 can specifically be a circuit or module that can control the displacement driving member 25 and form electrical coordination with the electrical module 31. In some embodiments, the control component 21 includes a display screen to show status information.

In some embodiments, combining FIGS. 22 and 23, the base 20 is connected with a first worm 27 and a transmission shaft 28. The first worm 27 is rotatably mounted on the base 20. The transmission shaft 28 is rotatably mounted on the base 20. In some embodiments, the outer periphery of the transmission shaft 28 is fixedly connected with a first worm wheel 29, and the first worm 27 meshes with the first worm wheel 29. In other embodiments, the outer periphery of the transmission shaft 28 is formed with a first worm wheel structure, and the first worm 27 meshes with the first worm wheel structure. The output shaft of the displacement driving member 25 is connected to the first worm 27. The transmission component 26 is connected between the transmission shaft 28 and the sliding seat 30. The transmission shaft 28 forms a transmission fit with the sliding seat 30 through the transmission component 26. When the transmission shaft 28 rotates, it can cause the sliding seat 30 to slide relative to the base 20. Specifically, when the sliding seat 30 moves relative to the base 20, the sliding seat 30 can drive the electronic control installation platform 900 to move in a straight line.

Specifically, the sliding seat 30 is guided to slide relative to the base 20 within a straight range. The output shaft of the displacement driving component member 25 can drive the first worm 27 to rotate, causing the first worm 27 to rotate around its own axis. When the first worm 27 meshes with the first worm wheel 29, the first worm wheel 29 can drive the transmission shaft 28 to rotate relative to the base 20. Due to the transmission coupling between the transmission shaft 28 and the sliding seat 30 through the transmission component 26, when the transmission shaft 28 rotates, it can cause the sliding seat 30 to slide relative to the base 20, thus enabling the displacement driving member 25 to adjust the position of the sliding seat 30. Under the transmission effect of the worm and worm wheel, the rotational speed of the transmission shaft 28 is much lower than that of the first worm 27, thus enabling precise control of the movement speed and position of the sliding seat 30, which is beneficial for improving the accuracy of the position control of the electronic control installation platform 900. In some embodiments, the transmission shaft 28 is formed with several worm gear teeth protruding outward on the outer peripheral side, and the worm gear teeth mesh and cooperate with the first worm 27.

In some embodiments, combining FIGS. 21 - 23, the transmission component 26 includes a driving wheel 261, a driven wheel 262, and a synchronous belt 263. The driving wheel 261 and the driven wheel 262 are respectively rotatably mounted on the base 20. The transmission shaft 28 forms a transmission fit with the driving wheel 261. The synchronous belt 263 is hung on the outer peripheral sides of the driving wheel 261 and the driven wheel 262. The sliding seat 30 is connected to the synchronous belt 263. Specifically, the sliding seat 30 is connected to a small section of the synchronous belt 263. When the driving wheel 261 rotates and a small section of the synchronous belt 263 moves in a straight line, the sliding seat 30 moves in a straight line under the traction of the synchronous belt 263. In some embodiments, the sliding seat 30 is connected with a clamp block 32, which is fixedly arranged with the synchronous belt 263, so that the synchronous belt 263 can drive the sliding seat 30 to move. More specifically, there are one or more driven wheel 262. In other embodiments, the transmission component 26 includes a screw, which is threaded with the sliding seat 30. The transmission shaft 28 can drive the screw to rotate. When the screw rotates, it drives the sliding seat 30 to move in a straight line.

Furthermore, combining FIG. 23, the base 20 is equipped with a second radial bearing member 34. One end of the transmission shaft 28 is inserted into the second radial bearing member 34. The other end of the transmission shaft 28 is connected to the driving wheel 261.

In some implementations, the displacement driving member 25 is a stepper motor or a servo motor. In some implementations, the rotating driving member 33 is a stepper motor or a servo motor.

The above embodiments are only a description of the preferred embodiments of the present disclosure and do not limit the scope of the present disclosure. Without departing from the design spirit of the present disclosure, various modifications and improvements made by ordinary skilled persons in the art to the technical solution of the present disclosure should fall within the scope of protection determined by the claims of the present disclosure.

What is claimed is:

1. A photographic sliding rail apparatus, comprising:
a sliding rail;
a sliding seat slidably disposed on the sliding rail along a first direction;
a mounting seat rotatably disposed on the sliding seat around a second direction, the second direction being different from the first direction;
a first driving unit mounted on the sliding seat and configured to drive the sliding seat to slide along the first direction; and
a second driving unit mounted on the sliding seat and configured to drive the mounting seat to rotate about the second direction;
wherein an output shaft of the first driving unit and an output shaft of the second driving unit extend towards different directions.

2. The photographic sliding rail apparatus of claim 1, wherein the first driving unit comprises a first motor and a first transmission mechanism, and the second driving unit comprises a second motor and a second transmission mechanism; a rotating shaft of the first motor is connected to the sliding rail via the first transmission mechanism, and a rotating shaft of the second motor is connected to the mounting seat via the second transmission mechanism; in the second direction, the first transmission mechanism and the second transmission mechanism are located on opposite sides of a whole formed by the first motor and the second motor respectively.

3. The photographic sliding rail apparatus of claim 2, wherein a first rotating shaft of the first motor and a second rotating shaft of the second motor extend towards different directions.

4. The photographic sliding rail apparatus of claim 1, wherein the first driving unit comprises a first motor and a first transmission mechanism, and the second driving unit comprises a second motor and a second transmission mechanism; the first motor and the second motor are located in a first accommodation region, the first transmission mechanism is located in a second accommodation region, and the second transmission mechanism is located in a third accommodation region; along the second direction, the second accommodation region and the third accommodation region are located on two opposite sides of the first accommodation region respectively.

5. The photographic sliding rail apparatus of claim 1, wherein the second direction is perpendicular to the first direction.

6. The photographic sliding rail apparatus of claim 1, wherein the photographic sliding rail apparatus further comprises a battery, the battery is connected to the first driving unit and the second driving unit to supply power to the first driving unit and the second driving unit, and the battery is disposed in the sliding seat.

7. The photographic sliding rail apparatus of claim 2, wherein the sliding seat comprises a base; along the second direction, the base comprises a first side and a second side opposite to the first side; the rotating shaft of the first motor passes through the base from the first side towards the second side, and the rotating shaft of the second motor passes through the base from the second side towards the first side.

8. The photographic sliding rail apparatus of claim 7, wherein the base comprises a first portion and a second portion adjacent to the first portion, the first portion and the second portion are spaced apart from each other, the first portion is recessed from the first side toward the second side to form a first recess, the second portion is recessed from the second side toward the first side to form a second recess; a main body of the first motor is mounted in the first recess of the base, and a main body of the second motor is mounted in the second recess of the base.

9. The photographic sliding rail apparatus of claim 7, wherein the sliding seat further comprises a first housing and a second housing covering the first side and the second side of the base respectively, the first housing covers one side of the first driving unit, and the second housing covers one side of the second driving unit.

10. The photographic sliding rail apparatus of claim 7, wherein the sliding rail comprises a first slide rod and a second slide rod parallel to the first slide rod, and the first slide rod and the second slide rod are spaced apart from each other; each side of two sides of the base is provided with an engaging portion extending along the first direction, each engaging portion defines a slide groove therein; the sliding seat further comprises a cover plate and a bushing, the cover plate is engaged with the engaging portion of the base and covers an opening of the slide groove to form a channel, the first slide rod and the second slide rod are movably disposed within the channel formed by the engaging portions and the cover plate.

11. The photographic sliding rail apparatus of claim 2, wherein the first rotating shaft of the first motor and the second rotating shaft of the second motor are parallel to each other; the first transmission mechanism comprises a first synchronous pulley, a second synchronous pulley, a third synchronous pulley, a fourth synchronous pulley, a first synchronous belt and a second synchronous belt; the first synchronous pulley, the second synchronous pulley, the third synchronous pulley and the fourth synchronous pulley are all rotatably disposed on the sliding seat; the first synchronous pulley is connected to the first rotating shaft of the first motor; the first synchronous belt is wound around the first synchronous pulley and the second synchronous pulley; the third synchronous pulley is coaxially arranged with the second synchronous pulley; the second synchronous belt is wound around the third synchronous pulley and the fourth synchronous pulley; each of two ends of the second synchronous belt pass around one of the fourth synchronous pulleys respectively, and the two ends of the second synchronous belt are connected to two brackets connected to the sliding rail respectively.

12. The photographic sliding rail apparatus of claim 2, wherein the second transmission mechanism comprises a fifth synchronous pulley, a sixth synchronous pulley and a third synchronous belt; the fifth synchronous pulley and the sixth synchronous pulley are rotatably disposed on the sliding seat; the fifth synchronous pulley is connected to the second rotating shaft of the second motor; the third synchronous belt is wound around the fifth synchronous pulley and the sixth synchronous pulley; the mounting seat is connected to the sixth synchronous pulley.

13. The photographic sliding rail apparatus of claim 12, wherein the mounting seat comprises a shaft sleeve and a shaft table, the sixth synchronous pulley is coaxially arranged with the shaft sleeve, the shaft table is connected to the shaft sleeve, and the shaft table is configured to mount an electronic control installation platform.

14. The photographic sliding rail apparatus of claim 1, wherein a slip ring is provided between the sliding seat and the mounting seat, the slip ring comprises a fixed portion and a rotating portion, the fixed portion is fixedly connected to the sliding seat, the rotating portion is rotatably sleeved within the fixed portion, and the rotating portion being fixedly connected to the mounting seat; the fixed portion is electrically connected to an electrical module inside the sliding seat, and the mounting seat is provided with conductive terminals, the rotating portion is electrically connected to the conductive terminals.

15. The photographic sliding rail apparatus of claim 1, wherein the photographic sliding rail apparatus further comprises two brackets and a plurality of legs, two ends of the sliding rail is fixedly connected to one bracket; the legs are movably connected to the brackets such that each leg has a first support state and a second support state; in the first support state, each leg is received in a groove of the brackets; in the second support state, the leg at least partially extends out of the groove of the bracket in the second direction.

16. The photographic sliding rail apparatus of claim 7, wherein a first circuit board is provided in the sliding seat, the first circuit board is electrically connected to the first motor and the second motor, and the first circuit board is fixedly mounted on the base of the sliding seat.

17. A photographic sliding rail apparatus, comprising:
a sliding rail;
a sliding seat slidably arranged on the sliding rail in a first direction;
a mounting seat rotatably arranged on the sliding seat about a second direction, the second direction being different from the first direction;
a first drive assembly mounted on the sliding seat and configured to drive the sliding seat to slide along the first direction;
a second drive assembly mounted on the sliding seat and configured to drive the mounting seat to rotate about the second direction; and
a battery electrically connected to a first motor of the first drive assembly and a second motor of the second drive assembly to supply power to the first motor and the second motor, wherein the battery is disposed inside the sliding seat.

18. The photographic sliding rail apparatus of claim 17, wherein the first drive assembly further comprises a first transmission mechanism, the second drive assembly further comprises a second transmission mechanism; and along the second direction, the first transmission mechanism, the second transmission mechanism, and the combination of the first motor and the second motor as a whole are arranged in three layers.

19. A photographic equipment comprising:
a photographic apparatus; and
the photographic sliding rail apparatus according to claim 1;
wherein the photographic apparatus is connected to photographic sliding rail apparatus directly or indirectly.
